(19) United States
(12) Patent Application Publication
(10) Pub. No.: US 2004/0006916 A1
(43) Pub. Date: Jan. 15, 2004

(54) Method for operating a reformer installation for providing hydrogen-enriched gas, and reformer installation

(76) Inventors: Rolf Bruck, Bergisch Gladbach (DE); Jorg Zimmermann, Bad Munstereifel (DE)

Correspondence Address: LERNER AND GREENBERG, P.A., POST OFFICE BOX 2480, HOLLYWOOD, FL, 33022-2480, US

(21) Appl. No.: 10/619,159

(22) Filed: Jul. 14, 2003

Related U.S. Application Data
(63) Continuation of application No. PCT/EP02/00208, filed on Jan. 11, 2002.

(30) Foreign Application Priority Data
Jan. 12, 2001 (DE) 101 01 098.2

(51) Int. Cl. C01B 3/26; F01N 3/10; C01B 3/24

(52) U.S. Cl. 48/197 R; 423/651; 422/173; 422/174; 422/105; 48/127.9; 422/234; 422/211; 422/198; 422/199

(57) ABSTRACT

A method for operating a reformer installation for providing hydrogen-containing gas, especially during a starting phase of energy generation using a fuel cell, includes feeding an incoming stream to and discharging an outgoing stream from, the reformer unit, branching-off at least one outflowing partial stream from the outgoing stream, and feeding-back the outflowing partial stream, as an inflowing partial stream, to the incoming stream, to at least partially form a circulating stream. The outflowing partial stream has a composition corresponding to a composition of the outgoing stream upon emerging from the reformer unit. A reformer installation includes at least one reformer unit having feed and discharge lines and a line connecting the discharge line to the feed line, at least partially forming a circulating stream. The method and installation provide a highly efficient production of hydrogen and especially short times required for starting the reformer installation.

### CROSS-REFERENCE TO RELATED APPLICATION

This application is a continuation of copending International Application No. PCT/EP02/00208, filed Jan. 11, 2002, which designated the United States and was not published in English.

### BACKGROUND OF THE INVENTION

### FIELD OF THE INVENTION

The invention relates to a method for operating a reformer installation for providing hydrogen-enriched gas, in particular during a starting phase of energy generation using a fuel cell. The invention also relates to a reformer installation.

The use of fuel cells is increasingly being considered as part of ongoing discussions on the topic of energy, and reformers are being developed which produce the hydrogen required for the fuel cells from hydrocarbons in situ. Different chemical reactions take place in the reformer depending on the hydrocarbon being used.

In certain application areas, fast-changing and extensive load changes occur at the fuel cell, and a reformer has to be able to generate sufficient quantities of hydrogen quickly. That problem arises in particular with applications in the automotive sector during a starting phase, when the reformer has to quickly reach the temperature required for the catalytic reaction for the production of hydrogen.

U.S. Pat. No. 5,433,072 has disclosed a catalytic converter for reducing the levels of pollutants in the exhaust gas from an internal combustion engine, which is electrically preheated under sensor control. That is done so that the temperature required for the catalytic reaction is reached without any additional waiting while the operator is climbing into a vehicle.

### SUMMARY OF THE INVENTION

It is accordingly an object of the invention to provide a method for operating a reformer installation for providing hydrogen-enriched gas, and a reformer installation, which overcome the hereinafore-mentioned disadvantages of the heretofore-known methods and devices of this general type and which provide a hydrogen-enriched gas, in particular during a starting phase of energy generation using a fuel cell.

With the foregoing and other objects in view there is provided, in accordance with the invention, a method for operating a reformer installation for providing hydrogen-containing gas, in particular during a starting phase of energy generation using a fuel cell, which comprises the following steps: feeding an incoming stream to a first reformer unit, discharging an outgoing stream from the first reformer unit, branching-off at least one outflowing partial stream from the outgoing stream, feeding-back the at least one outflowing partial stream, as an inflowing partial stream, to the incoming stream, to at least partially form a circulating stream. The outflowing partial stream has a composition corresponding to a composition of the outgoing stream upon emerging from the first reformer unit.

The incoming stream is substantially composed of two parts, the inflowing partial stream and an input stream which contains the hydrocarbons required for the reaction. The outgoing stream is the gas stream which is discharged from the first reformer unit, i.e. which contains the unreacted starting materials and the products of the first reformer unit. The incoming stream, the outgoing stream, the outflowing partial stream and the inflowing partial stream at least in part form the circulating stream.

In this context, the composition of the outflowing partial stream corresponds to the composition of the outgoing stream when it emerges from the first reformer unit. In this context, in some cases only part of the outgoing stream is recirculated. The circulating stream has two benefits. Firstly, the first reformer unit is utilized more effectively, since the gas boundary layer thickness at the catalytic coating is reduced by the movement of the circulating stream, so that more efficient catalysis can take place. Secondly, it is possible in this way to provide a greater quantity of hydrogen, in particular during the starting phase of energy generation using a fuel cell. The composition of the outflowing partial stream corresponds to the composition of the outgoing stream when it emerges from the first reformer unit. This results in considerable flexibility, for example with regard to gas purity. In this way, it is possible, according to demand, to purify either only the outflowing partial stream, the residue of the outgoing stream that remains after the outflowing partial stream has been branched off or both.

In accordance with another mode of the invention, the circulating stream is heated. The reaction is exothermic or endothermic, depending on the type of catalytic conversion of the hydrocarbons. In the case of endothermic reactions, the fuel or the catalytic converter has to be heated to and held at the required ignition temperature of the catalytic converter. In the case of exothermic reactions, there is no need to add any further heat when the reaction has started.

In accordance with a further mode of the invention, the circulating stream is conveyed through a pump. The flow boundary layers at the catalytic converter are reduced in size with the aid of the movement of the gas, so that the reformer unit is made more efficient. This allows a reformer unit to have smaller dimensions for the same production of hydrogen, resulting in cost benefits. The term pump is also synonymous, for example, with the term compressor. If the reformer installation is operated under pressure, it is advantageously possible to use the pump to compress the partial stream, in order to compensate for any pressure losses in this way. In this context, it is advantageous for the volumetric flow of the partial stream to be lower than that of the incoming stream, so that lower compressor work has to be provided.

In accordance with an added mode of the invention, the circulating stream flows through a second reformer unit, by which it is heated. The combination of the first and second reformer units allows the heat which is released from one reformer unit to be used to operate the other reformer unit. It is possible to increase the overall efficiency of the reformer installation considerably by combining an exothermic reaction in one reformer installation and an endothermic reaction in the other reformer installation. There is no need for further heat to be either fed to or dissipated from the circulating stream.

In accordance with an additional mode of the invention, the circulating stream is heated by electric heating. Electric heating can be achieved using particularly simple measures, especially during the starting phase of energy generation. In this way, the required ignition temperature of the catalytic converter can be reached quickly, i.e. within a few seconds.

In accordance with yet another mode of the invention, the circulating stream is heated by partial oxidation of hydrocarbons.

In accordance with yet a further mode of the invention, the circulating stream flows at least in part through a fuel cell. This firstly makes it possible to utilize the heat which is released at the fuel cell to heat a reformer unit, and secondly means that the hydrogen which is generated at one reformer unit is immediately available to the fuel cell. Furthermore, the flow of the gas and the associated reduction in the boundary layer thickness increases the efficiency of the fuel cell, with the result that the latter can have smaller dimensions and can be produced at lower cost.

In accordance with yet an added mode of the invention, the circulating stream is very much larger than an input stream which is fed to the incoming stream. This ensures that a gas molecule on average passes through the reformer device a number of times, thus increasing the probability of catalytic conversion. In a specific refinement of the method according to the invention, the circulating stream is at least ten times as large as the input stream.

In accordance with yet an additional mode of the invention, the reformer installation is set in operation by a remote control. This enables the operator, for example when the reformer installation is used in an automobile, to set the reformer installation in operation even before the operator gets into the vehicle, so that the automobile can be started up more quickly.

In accordance with again another mode of the invention, the reformer installation is set in operation by a signal from a first sensor. The result of this is that the reformer installation is heated to the required temperature as quickly as possible. This is important in particular if the starting phase of operation of a fuel cell is to take place as quickly as possible, as is the case, for example, when an automobile is being started.

In accordance with again a further mode of the invention, the ignition temperature of the first reformer unit or of the second reformer unit is reached in less than 20 seconds, preferably 10 seconds, in particular 5 seconds. The ability of a fuel cell with a reformer unit to be used in an automobile is crucially dependent on the time which is required to reach the required electric power. Acceptable starting times can be achieved with the aid of the circulating stream according to the invention.

In accordance with again an added mode of the invention, there is provided a first sensor determining a characteristic variable which is used to regulate the level of the incoming stream and/or of the outgoing stream and/or of the outflowing partial stream and/or of the inflowing partial stream. For example, if no hydrogen is being consumed, the input stream or the output stream is stopped. The circulating stream is maintained until the maximum hydrogen concentration has been reached and is then likewise reduced. The size of the circulating stream can also be regulated as a function of another substance concentration or the temperature or the pressure.

In accordance with again an added mode of the invention, the characteristic variable is proportional to a concentration of a substance in the circulating stream, in particular that of hydrogen. This advantageously enables the circulating stream to be regulated as a function of the hydrogen concentration. This allows very rapid adaptation of the circulating stream as a response to changes in the hydrogen concentration.

In accordance with again an additional mode of the invention, the characteristic variable is proportional to a physical variable of the circulating stream, in particular the temperature.

In accordance with still another mode of the invention, the circulating stream is heated if the temperature is below a predetermined temperature, in particular below 100° C. In particular in a starting phase of the reformer installation, it is possible in this way to rapidly heat the reformer unit to operating temperature, so that hydrogen concentrations which are required for operation of a fuel cell are reached more quickly in the outgoing stream or in the circulating stream. The temperature is predetermined as a function of the reformer unit being used.

With the objects of the invention in view, there is also provided a reformer installation for providing hydrogen-containing gas, in particular during a starting phase of energy generation using a fuel cell, comprising at least one reformer unit, a feed line leading to the at least one reformer unit, a discharge line leading from the at least one reformer unit and carrying an outgoing stream emerging from the at least one reformer unit, and a line connecting the discharge line to the feed line and carrying an outflowing partial stream of the outgoing stream to the feed line, for at least partially forming a circulating stream. The outflowing partial stream has a composition corresponding to a composition of the outgoing stream upon emerging from the at least one reformer unit. The catalytic conversion of the hydrocarbons to form hydrogen takes place at the reformer unit.

In accordance with another feature of the invention, there is provided a heating device for heating the circulating stream. With this device it is possible, in particular in a starting phase of the reformer installation, to rapidly heat the reformer unit to operating temperature utilizing the circulating stream and in this way to generate a sufficiently high concentration of hydrogen in the outgoing stream within acceptable times. As a result, it is advantageously possible for a fuel cell which is operated with the outgoing stream or the circulating stream to commence operation quickly.

In accordance with another feature of the invention, there is provided a second reformer unit as a heating device. The combination of two reformer units advantageously makes it possible to use an exothermically operating reformer unit which, for example, carries out the partial oxidation to heat an endothermically operating reformer unit which, for example, carries out a steam reforming operation.

In accordance with another feature of the invention, there is provided an electric heater device which heats the circulating stream.

In accordance with a further feature of the invention, there is provided a pump. The term pump is, for example, also synonymous for a compressor. If the reformer unit is operated under pressure, it is advantageously possible to use the pump to compress the partial stream in order to compensate for any pressure losses in this way. If the volumetric flow of the circulating stream is lower than that of the input stream, it is advantageously possible to reduce the compressor work.

In accordance with an added feature of the invention, there is provided a remote control for remote-controlled starting of the reformer installation. This allows the reformer installation to be started up, for example by the operator of a vehicle which is operated by using fuel cells, even before the operator has climbed into the vehicle, without the need for additional waiting before the required temperature of the reformer device is reached.

In accordance with an additional feature of the invention, there is provided a first sensor for regulating the circulating stream. In a particular embodiment, the first sensor is a temperature sensor. This is used to measure the temperature in the circulating stream and/or in the first reformer device. In a further preferred configuration of the reformer installation according to the invention, the first sensor is a substance-concentration sensor, in particular for hydrogen. The addition of hydrocarbons and/or the size of at least one stream (incoming stream, outgoing stream, circulating stream, input stream, output stream, outflowing partial stream or inflowing partial stream) is set on the basis of data from the first sensor.

In accordance with yet another feature of the invention, there is provided a second sensor for early starting of the reformer installation. This sensor records the proximity of a person, e.g. by optical measures or mechanical switches, so that the reformer installation starts to operate when the operator approaches, even before he or she has climbed into the vehicle, so that the required temperature of the reformer device is reached without additional waiting time.

In accordance with yet a further feature of the invention, the volume of the space in which the circulating stream is flowing is similar to the product of the starting time of the reformer installation and the temporal mean of the hydrogen-enriched gas flow which is required under normal circumstances. The starting time of the reformer installation is the time required after the installation has been switched on until the reformer installation commences conversion. This time is determined mainly by the duration which is required to reach the necessary temperature for catalytic conversion of the hydrocarbons. The temporal mean of the hydrogen-enriched gas flow corresponds to the mean quantity of hydrogen consumed per unit time. This ensures that during the starting phase of energy generation using a fuel cell, there are no power dips caused by an insufficient supply of hydrogen.

In accordance with yet an additional feature of the invention, depending on the type of fuel cell, it may be expedient to integrate an additional gas purification stage in the circuit. This protects the fuel cell from the harmful effects of impurities, in particular during the starting phase of the reformer installation.

In accordance with a concomitant feature of the invention, there is provided a directional control valve disposed in the feed line, the discharge line and/or in the line. This advantageously makes it possible to regulate the volumetric flow in the corresponding lines with a simplified structure.

Other features which are considered as characteristic for the invention are set forth in the appended claims.

Although the invention is illustrated and described herein as embodied in a method for operating a reformer installation for providing hydrogen-enriched gas, and a reformer installation, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic and block circuit diagram of a reformer installation with a heating device for heating a circulating stream;

FIG. 2 is a view similar to FIG. 1 of a reformer installation with a second reformer unit and a fuel cell; and

FIG. 3 is a view similar to FIGS. 1 and 2 of a reformer installation with a heater device and a fuel cell.

### DESCRIPTION OF THE PREFERRED EMBODIMENTS

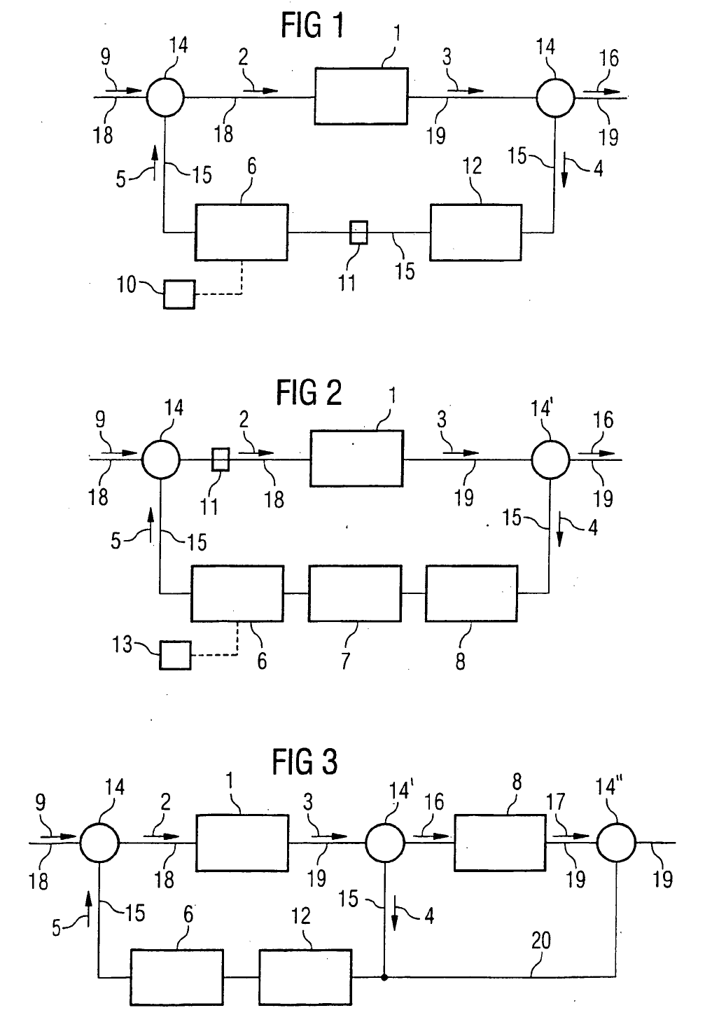

Referring now to the figures of the drawings in detail and first, particularly, to FIG. 1 thereof, there is seen a reformer installation according to the invention, having a first reformer unit or device 1, a heating device 12 and a pump 6, each of which are connected to one another by a line 15. A hydrocarbon-containing input stream 9 is fed to the system through a feed line 18. An inflowing partial stream 5 through the line 15 is fed to the input stream 9 in a directional control valve 14, so that the input stream 9 and the inflowing partial stream 5 form an incoming stream 2. The incoming stream 2 is catalytically converted in the reformer unit 1. An outgoing stream 3, which is discharged from the reformer unit 1 through a discharge line 19, is split at a directional control valve 14′ which is located in the discharge line 19. At least an outflowing partial stream 4 of the outgoing stream 3 is diverted into the line 15. The incoming stream 2, the outgoing stream 3, the outflowing partial stream 4 and the inflowing partial stream 5, form a circulating stream.

A first sensor 11 in the line 15 measures the hydrogen concentration in the outflowing partial stream 4 or in the inflowing partial stream 5. The pump 6 is set in operation by a remote control 10. The pump 6 may also, for example, be a compressor. The heating device 12 is used to heat the outflowing partial stream 4. The heating device 12 may operate electrically but may also be constructed as a heat exchanger. Furthermore, it is possible for a second reformer unit, which operates exothermically, to be used as the heating device 12. The composition of the outflowing partial stream 4 and of the inflowing partial stream 5 is identical.

FIG. 2 shows a reformer installation as shown in FIG. 1, in which the heating device 12 is replaced by a second reformer unit or device 7 and a fuel cell 8. The second reformer unit 7 serves the function of heating the circulating stream and/or reducing CO content by partial oxidation with an associated exothermic reaction. An integration of the fuel cell 8 in the line 15 enables the fuel cell 8 to be supplied with hydrogen directly. In the case of prolonged operation with major load changes, the heat of the fuel cell 8 is made available in the circulating stream and therefore to the reformer unit 1, which in this case uses an endothermic reaction to convert hydrocarbons, for example steam reforming. Even if no hydrogen is being used by the fuel cell 8 for a short time, the heat of the fuel cell 8 can be stored for the time being for subsequent use when a high electric power is required and can then be exploited. A second sensor 13, which is disposed as a pressure sensor at the seat of a vehicle, triggers a signal which switches on the pump 6 when the seat is occupied, so that the time for which the passengers have to wait before the reformer installation has started up is shortened.

FIG. 3 shows a reformer installation as shown in FIG. 1, except that a fuel cell 8 is not integrated in the line 15, but rather is integrated in the discharge line 19. An exhaust gas stream 17 discharged from the fuel cell 8 is at least in part fed through a line 20 to the partial stream 4 by a directional control valve 14″. This results in particularly high efficiency of the hydrogen utilization in particular during the starting phase.

The invention is distinguished in particular by the fact that the formation of a circulating stream results in a particularly high efficiency during the generation of a hydrogen-containing gas with the aid of a catalytic reaction and also that particularly short times are required to start up a reformer installation.

We claim:

1. A method for operating a reformer installation for providing hydrogen-containing gas, which comprises the following steps:
feeding an incoming stream to a reformer unit;
discharging an outgoing stream from the reformer unit;
branching-off at least one outflowing partial stream from the outgoing stream, the outflowing partial stream having a composition corresponding to a composition of the outgoing stream upon emerging from the reformer unit; and
feeding-back the at least one outflowing partial stream, as an inflowing partial stream, to the incoming stream, to at least partially form a circulating stream.

2. The method for operating a reformer installation according to claim 1, which further comprises heating the circulating stream.

3. The method for operating a reformer installation according to claim 1, which further comprises conveying the circulating stream through a pump.

4. The method for operating a reformer installation according to claim 1, which further comprises feeding the circulating stream through another reformer unit heating the circulating stream.

5. The method for operating a reformer installation according to claim 2, which further comprises carrying out the step of heating the circulating stream by partial oxidation of hydrocarbons.

6. The method for operating a reformer installation according to claim 2, which further comprises carrying out the step of heating the circulating stream by electric heating.

7. The method for operating a reformer installation according to claim 1, which further comprises at least partially feeding the circulating stream through a fuel cell.

8. The method for operating a reformer installation according to claim 1, which further comprises feeding an input stream, being much smaller than the circulating stream, to the incoming stream.

9. The method for operating a reformer installation according to claim 8, wherein the circulating stream is at least ten times as large as the input stream.

10. The method for operating a reformer installation according to claim 1, which further comprises setting the reformer installation in operation by a remote control.

11. The method for operating a reformer installation according to claim 1, which further comprises setting the reformer installation in operation by a signal from a sensor.

12. The method for operating a reformer installation according to claim 4, which further comprises reaching an ignition temperature of one of the reformer units in less than 20 s.

13. The method for operating a reformer installation according to claim 4, which further comprises reaching an ignition temperature of one of the reformer units in approximately 10 s.

14. The method for operating a reformer installation according to claim 4, which further comprises reaching an ignition temperature of one of the reformer units in approximately 5 s.

15. The method for operating a reformer installation according to claim 1, which further comprises determining a characteristic variable with a sensor for regulating a level of at least one of: the incoming stream, the outgoing stream, the outflowing partial stream and the inflowing partial stream.

16. The method for operating a reformer installation according to claim 15, wherein the characteristic variable is proportional to a concentration of a substance in the circulating stream.

17. The method for operating a reformer installation according to claim 16, wherein the concentration of the substance is a concentration of hydrogen.

18. The method for operating a reformer installation according to claim 15, wherein the characteristic variable is proportional to a physical variable of the circulating stream.

19. The method for operating a reformer installation according to claim 18, wherein the physical variable is temperature.

20. The method for operating a reformer installation according to claim 19, which further comprises heating the circulating stream if the temperature falls below a predetermined temperature.

21. The method for operating a reformer installation according to claim 20, wherein the predetermined temperature is 100° C.

22. The method for operating a reformer installation according to claim 1, which further comprises operating the reformer installation during a starting phase of energy generation using a fuel cell.

23. A reformer installation for providing hydrogen-containing gas, comprising:
at least one reformer unit;
a feed line leading to said at least one reformer unit;
a discharge line leading from said at least one reformer unit and carrying an outgoing stream emerging from said at least one reformer unit; and
a line connecting said discharge line to said feed line and carrying an outflowing partial stream of said outgoing stream to said feed line, for at least partially forming a circulating stream, said outflowing partial stream having a composition corresponding to a composition of said outgoing stream upon emerging from said at least one reformer unit.

24. The reformer installation according to claim 23, which further comprises a heating device disposed in said line.

25. The reformer installation according to claim 24, wherein said heating device is another reformer unit.

26. The reformer installation according to claim 24, wherein said heating device is an electric heating device.

27. The reformer installation according to claim 23, which further comprises a pump disposed in said line.

28. The reformer installation according to claim 23, which further comprises a remote control for remote-controlled start up of the reformer installation.

29. The reformer installation according to claim 23, which further comprises a sensor for regulating said circulating stream.

30. The reformer installation according to claim 29, wherein said sensor is a temperature sensor.

31. The reformer installation according to claim 29, wherein said sensor is a substance-concentration sensor.

32. The reformer installation according to claim 29, wherein said sensor is a hydrogen-concentration sensor.

33. The reformer installation according to claim 23, which further comprises a sensor for starting up the reformer installation by an operator of a vehicle operated by fuel cells before the operator enters the vehicle.

34. The reformer installation according to claim 23, wherein said circulating stream flows in a volume of space similar to a product of a starting time required by the reformer installation and a temporal mean of a hydrogen-enriched volumetric flow of gas.

35. The reformer installation according to claim 23, which further comprises a respective directional control valve disposed in at least one of said feed line, said discharge line and said line.

36. A reformer installation for providing hydrogen-containing gas during a starting phase of energy generation using a fuel cell, comprising:
at least one reformer unit;
a feed line leading to said at least one reformer unit;
a discharge line leading from said at least one reformer unit and carrying an outgoing stream emerging from said at least one reformer unit;
a line connecting said discharge line to said feed line and carrying an outflowing partial stream of said outgoing stream to said feed line, for at least partially forming a circulating stream, said outflowing partial stream having a composition corresponding to a composition of said outgoing stream upon emerging from said at least one reformer unit; and
a fuel cell disposed in said line.
